(19) United States
(12) Patent Application Publication
(10) Pub. No.: US 2022/0245518 A1
(43) Pub. Date: Aug. 4, 2022

(54) DATA TRANSFORMATION APPARATUS, PATTERN RECOGNITION SYSTEM, DATA TRANSFORMATION METHOD, AND NON-TRANSITORY COMPUTER READABLE MEDIUM

(71) Applicant: NEC Corporation, Minato-ku, Tokyo (JP)

(72) Inventors: Masato ISHII, Tokyo (JP); Takashi TAKENOUCHI, Saitama (JP); Masashi SUGIYAMA, Saitama (JP)

(73) Assignee: NEC Corporation, Minato-ku, Tokyo (JP)

(21) Appl. No.: 17/610,488

(22) PCT Filed: May 22, 2019
(86) PCT No.: PCT/JP2019/020218

§ 371 Date: Nov. 11, 2021

(51) Int. Cl. G06N 20/00; G06F 16/25; G06F 16/28

(52) U.S. Cl. CPC G06N 20/00; G06F 16/285; G06F 16/258

(57) ABSTRACT

A data transformation apparatus (1) includes: data transformation means (11) for performing data transformation on each of a plurality of data sets so that data distributions of the plurality of data sets are brought close to each other; first calculation means (12) for calculating a class classification loss from a result of class classification performed by class classification means on at least some of a plurality of first transformed data sets obtained after the data transformation; second calculation means (13) for calculating an upper bound and a lower bound of a domain classification loss from a result of domain classification performed by domain classification means on each of the plurality of first transformed data sets; and first learning means (14) for performing first learning by updating a parameter of the domain classification means so that the upper bound is reduced and updating a parameter of the data transformation means so that the class classification loss is reduced and the lower bound is increased.

### TECHNICAL FIELD

The present disclosure relates to a data transformation apparatus, a pattern recognition system, a data transformation method, and a non-transitory computer readable medium.

### BACKGROUND ART

Non Patent Literature 1 discloses a technique related to domain adaptation for performing data transformation so that the distributions of data among a plurality of data sets coincide with each other, the plurality of data sets belonging to domains different from each other. Further, Non Patent Literature 2 discloses a method for maximizing an Area Under the Curve (AUC), which is a classification evaluation index effective for learning imbalanced data, by using a function that is easy to optimize and becomes a lower bound of the AUC as a proxy AUC.

### CITATION LIST

### Non Patent Literature

Non Patent Literature 1: Y. Ganin, E. Ustinova, H. Ajakan, P. Germain, H. Larochelle, F. Laviolette, M. Marchand, and V. Lempitsky, “Domain-Adversarial Training of Neural Networks,” Journal of Machine Learning Research, vol. 17, num. 59, pp. 1-35, 2016.
Non Patent Literature 2: W. Gao, R. Jin, S. Zhu, and Z.-H. Zhou, “One-pass AUC Optimization,” International Conference on Machine Learning, 2013.

### SUMMARY OF INVENTION

### Technical Problem

In the above-described Non Patent Literature 1, a cross entropy loss is predominantly used, and thus it is difficult to flexibly change a loss function in accordance with problems. Therefore, there is a problem that the accuracy of data transformation for bringing the data distributions among a plurality of data sets belonging to the different domains close to each other is insufficient. Note that the method disclosed in Non Patent Literature 2 is a method for maximizing the AUC, and thus the above problem cannot be solved by this method.

The present disclosure has been made to solve the above-described problem and an object thereof is to provide a data transformation apparatus, a pattern recognition system, a data transformation method, and a non-transitory computer readable medium storing a data transformation program that are for improving the accuracy of data transformation for bringing data distributions among a plurality of data sets belonging to different domains close to each other.

### Solution to Problem

A data transformation apparatus according to a first example aspect of the present disclosure includes:

data transformation means for performing data transformation on each of a plurality of data sets belonging to domains different from each other so that data distributions of the plurality of data sets are brought close to each other;

first calculation means for calculating a class classification loss from a result of class classification performed by class classification means on at least some of a plurality of first transformed data sets obtained after the data transformation;

second calculation means for calculating an upper bound and a lower bound of a domain classification loss from a result of domain classification performed by domain classification means on each of the plurality of first transformed data sets; and

first learning means for performing first learning by updating a parameter of the domain classification means so that the upper bound is reduced and updating a parameter of the data transformation means so that the class classification loss is reduced and the lower bound is increased.

A pattern recognition system according to a second example aspect of the present disclosure includes:

data transformation means for performing data transformation on each of a plurality of data sets belonging to domains different from each other so that data distributions of the plurality of data sets are brought close to each other;

first calculation means for calculating a class classification loss from a result of class classification performed by class classification means on at least some of a plurality of first transformed data sets obtained after the data transformation;

second calculation means for calculating an upper bound and a lower bound of a domain classification loss from a result of domain classification performed by domain classification means on each of the plurality of first transformed data sets;

first learning means for performing first learning by updating a parameter of the domain classification means so that the upper bound is reduced and updating a parameter of the data transformation means so that the class classification loss is reduced and the lower bound is increased;

second learning means for performing second learning of a pattern recognition model by using a plurality of second transformed data sets obtained by the data transformation performed again on each of the plurality of data sets by the data transformation means in which the parameter obtained after the first learning is set; and

recognition means for performing pattern recognition on a data set input by using the pattern recognition model in which the parameter obtained after the second learning is set.

A data transformation method according to a third example aspect of the present disclosure includes:

performing, by a computer, data transformation using a data transformer on each of a plurality of data sets belonging to domains different from each other so that data distributions of the plurality of data sets are brought close to each other;

calculating, by the computer, a class classification loss from a result of class classification performed by a class classifier on at least some of a plurality of first transformed data sets obtained after the data transformation;

calculating, by the computer, an upper bound and a lower bound of a domain classification loss from a result of domain classification performed by a domain classifier on each of the plurality of first transformed data sets; and

performing, by the computer, learning by updating a parameter of the domain classifier so that the upper bound is reduced and updating a parameter of the data transformer so that the class classification loss is reduced and the lower bound is increased

A non-transitory computer readable medium storing a data transformation program according to a fourth example aspect of the present disclosure causes a computer to execute:

data transformation processing for performing data transformation using a data transformer on each of a plurality of data sets belonging to domains different from each other so that data distributions of the plurality of data sets are brought close to each other;

first calculation processing for calculating a class classification loss from a result of class classification performed by a class classifier on at least some of a plurality of first transformed data sets obtained after the data transformation;

second calculation processing for calculating an upper bound and a lower bound of a domain classification loss from a result of domain classification performed by a domain classifier on each of the plurality of first transformed data sets; and

learning processing for performing learning by updating a parameter of the domain classifier so that the upper bound is reduced and updating a parameter of the data transformer so that the class classification loss is reduced and the lower bound is increased.

### Advantageous Effects of Invention

According to the above-described example aspects, it is possible to provide a data transformation apparatus, a pattern recognition system, a data transformation method, and a non-transitory computer readable medium storing a data transformation program that are for improving the accuracy of data transformation for bringing data distributions among a plurality of data sets belonging to different domains close to each other.

### BRIEF DESCRIPTION OF DRAWINGS

FIG. 1 is a block diagram showing an overall configuration of a data transformation apparatus according to a first example embodiment;

FIG. 2 is a flowchart showing a flow of a data transformation method according to the first example embodiment;

FIG. 3 is a block diagram showing a configuration of a data transformation apparatus according to a second example embodiment;

FIG. 4 is a diagram for explaining a relation between loss functions according to the second example embodiment;

FIG. 5 is a block diagram showing a hardware configuration of the data transformation apparatus according to the second example embodiment;

FIG. 6 is a flowchart showing a flow of a data transformation method according to the second example embodiment;

FIG. 7 is a diagram for explaining a relation among a source data set and a target data set and a data transformer, a class classifier, and a domain classifier according to the second example embodiment;

FIG. 8 is a block diagram showing a configuration of a pattern recognition system according to a third example embodiment;

FIG. 9 is a block diagram showing a hardware configuration of a pattern recognition apparatus according to the third example embodiment;

FIG. 10 is a flowchart showing a flow of pattern recognition processing according to the third example embodiment;

FIG. 11 is a diagram for explaining occurrence of a problem; and

FIG. 12 is a diagram for explaining a concept of class classification after domain adaptation is performed.

### EXAMPLE EMBODIMENTS

Example embodiments according to the present disclosure will be described hereinafter in detail with reference to the drawings. The same elements are denoted by the same reference symbols throughout the drawings, and redundant descriptions will be omitted as necessary for the sake of clarity.

A supplementary explanation regarding the problems to be solved by the example embodiments according to the present disclosure will be provided below. First, a pattern recognition technology is a technology for estimating a class to which an input pattern belongs. Specific examples of the pattern recognition include object recognition for estimating, using an image as an input, an object included in the image, and voice recognition for estimating, using a voice as an input, the content of a speech.

Machine learning has been widely used to achieve pattern recognition. In supervised learning, a training sample (training data) to which a label indicating a result of recognition is assigned is collected in advance, and a model indicating a relation between the training data and the label is created based on the training sample and the label. The created model is applied to an unlabeled test sample (test data) to be recognized, whereby a result of the pattern recognition is obtained.

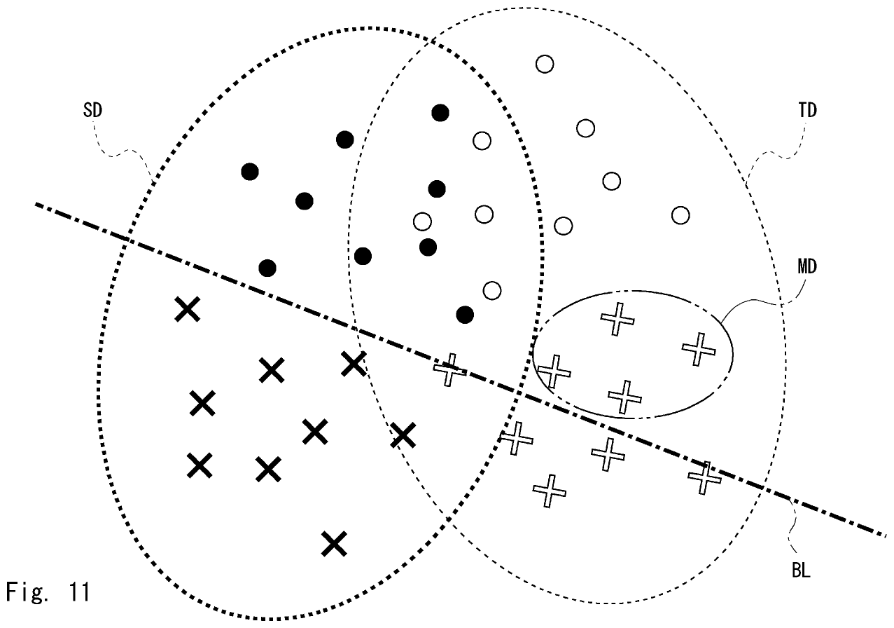

In a large number of machine learning techniques, it is assumed that the distribution of the training data coincides with the distribution of the test data. However, in general, an environment (a domain) for acquiring training data and an environment for acquiring test data are often different, and the distribution of the data changes due to the difference between the environments. When the distribution of the training data is different from that of the test data, a problem occurs in which the performance of pattern recognition is reduced in accordance with the degree of the difference as shown in FIG. 11.

In FIG. 11, it is shown that source data SD is a data set (training data) (obtained before data transformation described later) and a plurality of data pieces of black circles and black x marks are distributed. Further, it is shown that target data TD is a data set (test data) (obtained before data transformation) and a plurality of data pieces of white circles and white x marks are distributed. Here, the circles and the x marks indicate respective classes. For example, the circle indicates data to which a positive label is assigned and the x mark indicates data to which a negative label is assigned. Further, it is shown that the data distribution of the source data SD is deviated from the data distribution of the target data TD since the range in which the source data SD is distributed is different from the range in which the target data TD is distributed. Further, a class classification boundary BL indicates a boundary line of class classification set in response to the learning of a predetermined class classifier using the source data SD as teacher data. It is shown as an example that, in this case, when the class of each data (sample) of the target data TD is determined in accordance with the class classification boundary BL, some pieces of misrecognition data MD (four white x marks) are generated among the target data TD.

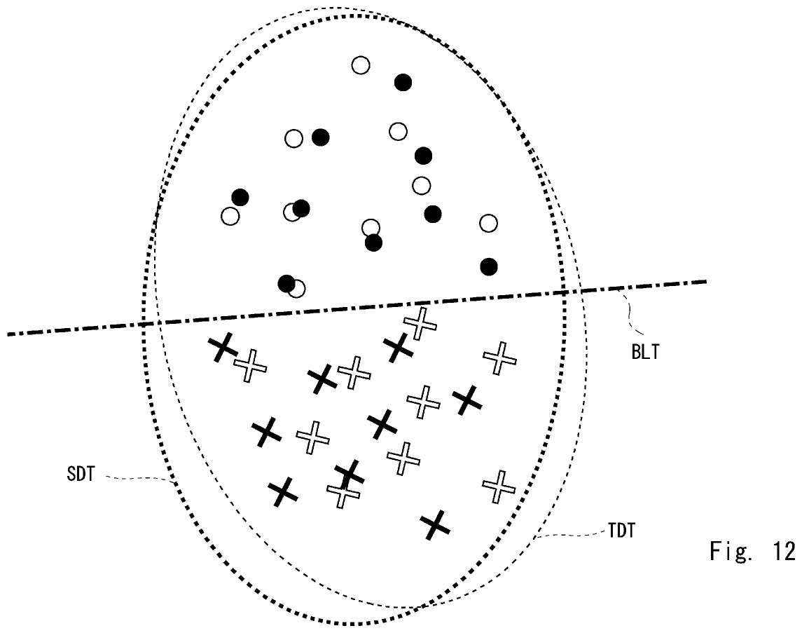

In order to avoid the aforementioned problem, a technique called domain adaptation that performs data transformation (e.g., feature transformation) so that the distributions of data are made to coincide with each other has been proposed. For example, domain adaptation (data transformation) is performed between the training data and the test data in advance, to thereby bring the data distribution of the training data and the data distribution of the test data close to each other as shown in FIG. 12. Then, a class classifier is created for training data (transformed source data SDT) obtained before the adaptation. By doing so, the class classifier is created by using the source data SD having little deviation from the distribution of the target data TD. Thus, it is possible to achieve, by (a class classification boundary BLT of) the trained class classifier, a high recognition performance for test data (transformed target data TDT) obtained before the adaptation. Note that, in the domain adaptation, the adaptation source may be referred to as a source domain, the data of the source domain may be referred to as source data, the adaptation destination may be referred to as a target domain, and the data of the target domain may be referred to as target data.

Many of the recent domain adaptations (e.g., Non Patent Literature 1) employ an adversarial learning framework. In this framework, a domain classifier that distinguishes to which domain the data obtained after data transformation belongs is introduced. In domain adaptation learning, a domain classifier is trained so as to increase the classification accuracy (precision accuracy) of the domain classifier, and at the same time, a data transformer that performs data transformation processing is trained so as to reduce the precision accuracy of the domain classifier. The domain classifier is a classifier that determines whether certain data is in a source domain or a target domain. By performing adversarial learning as described above, it is possible to obtain a data transformer that performs transformation of data into other data which cannot be distinguished from the former data even by a domain classifier that has been sufficiently trained. That is, it is possible to obtain a data transformer in which the data distribution of the source domain obtained after the data transformation sufficiently coincides with the data distribution of the target domain obtained after the data transformation (i.e., there is little deviation between these distributions).

Note that a cross entropy loss is often used for adversarial learning. This is because a neural network can often be trained efficiently by using a cross entropy loss. At this time, in the learning of a domain classifier, a parameter of the domain classifier is updated so that the cross entropy loss is reduced, while in the learning of a data transformer, a parameter of the data transformer is updated so that the cross entropy loss is increased.

Note that, in the domain adaptation based on the adversarial learning according to the related art such as Non Patent Literature 1, an approach that “regarding a single loss function, a domain classifier is minimized, while a data transformer is maximized” is adopted. Consequently, only a loss function that can be both maximized and minimized efficiently and effectively can be used. Therefore, a cross entropy loss is predominantly used in the related art, and thus it is difficult to flexibly change the loss function in accordance with problems.

For example, assume a case in which an amount of target data is significantly smaller than that of source data. In this case, the domain classifier distinguishes (determines) that input data is source data regardless of a type of the input data, thereby achieving a high classification rate for domain classification. However, since no meaningful classification is actually performed, domain adaptation cannot be effectively performed even if adversarial learning is performed on the aforementioned domain classifier. Therefore, it is conceivable to use an Area Under the Curve (AUC), which is a classification evaluation index effective for learning imbalanced data, for calculating the loss in order to train the domain classifier. However, it is difficult to use it for adversarial learning. This is because the AUC calculated from the data is a discontinuous function for the parameter, and it is thus difficult to efficiently perform maximization and minimization. On the other hand, for example, the above-described Non Patent Literature 2 proposes a method for efficiently maximizing the AUC by using a function that is easy to optimize and becomes a lower bound of the AUC as a proxy AUC. However, the method disclosed in Non Patent Literature 2 is a method for maximizing the AUC, and thus it is not possible to effectively perform the minimization necessary for adversarial learning.

The present disclosure has been made in order to solve at least some of the above-described problems, and each example embodiment will be described below.

### First Example Embodiment

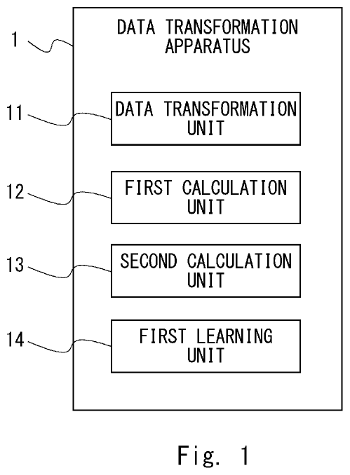

FIG. 1 is a block diagram showing an overall configuration of a data transformation apparatus 1 according to a first example embodiment. The data transformation apparatus 1 is a computer that trains at least data transformation means and domain classification means by using a plurality of data sets belonging to domains different from each other and then performs data transformation of each data set by the trained data transformation means. It is assumed here that the data set is, for example, a set (feature information, feature vectors) of feature data extracted from a specific image, voice data, and the like, and belongs to any domain. The feature information can be implemented by, for example, a Scale-Invariant Feature Transform (SIFT) feature value, and a Speeded-Up Robust Feature (SURF). Further, the data transformation means, the domain classification means, and the class classification means described later are respectively, for example, a data transformer, a domain classifier, and a class classifier, which are hardware or software modules that perform predetermined processing using a set (parameter) of one or more set values. The data transformation apparatus 1 includes a data transformation unit 11, a first calculation unit 12, a second calculation unit 13, and a first learning unit 14.

The data transformation unit 11 is an example of data transformation means for performing data transformation on each of a plurality of data sets belonging to domains different from each other so that data distributions of the plurality of data sets are brought close to each other. Note that the number of the plurality of data sets is at least two or more, and the plurality of data sets may include, for example, a source data set belonging to a source domain and a target data set belonging to a target domain. Further, the data transformation unit 11 generates, from each data set, a plurality of first transformed data sets obtained after the data transformation. That is, the data transformation unit 11 individually transforms each of the plurality of data sets into a transformed data set. Note that the data transformation unit 11 may collectively perform data transformation on a plurality of data sets. Further, the data transformation unit 11 may perform data transformation so that the data distributions of some of the plurality of data sets are brought close to those of the remaining data sets.

The first calculation unit 12 is an example of first calculation means for calculating a class classification loss from a result of class classification performed by class classification means on at least some of the plurality of first transformed data sets. Note that the first calculation unit 12 may use the results of the class classification performed on all the data of the plurality of first transformed data sets. Further, class classification processing performed by the class classification means may be executed either outside or inside the data transformation apparatus 1.

The second calculation unit 13 is an example of second calculation means for calculating an upper bound and a lower bound of a domain classification loss from a result of domain classification performed by domain classification means on each of a plurality of first transformed data sets. The domain classification processing performed by the domain classification means may be executed either outside or inside the data transformation apparatus 1.

The first learning unit 14 updates a parameter of the domain classification means so that the upper bound is reduced (for example, the upper bound is minimized). Further, the first learning unit 14 updates a parameter of the data transformation means so that the class classification loss is reduced (for example, the class classification loss is minimized) and the lower bound is increased (for example, the lower bound is maximized). The first learning unit 14 is an example of first learning means for performing first learning by performing at least the aforementioned updating of the parameters of the domain classification means and the data transformation means.

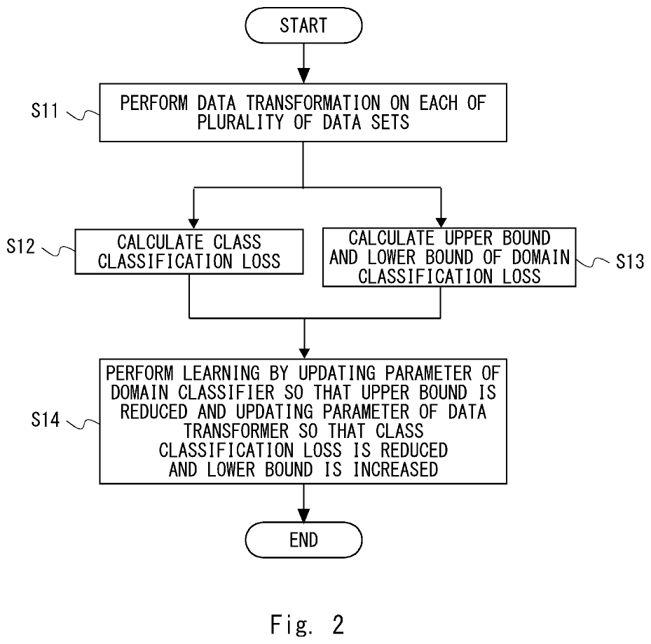

FIG. 2 is a flowchart showing a flow of a data transformation method according to the first example embodiment. First, the data transformation apparatus 1 performs data transformation on each of a plurality of data sets belonging to domains different from each other by using a data transformer so that the data distributions of the plurality of data sets are brought close to each other (S11).

Next, the data transformation apparatus 1 calculates a class classification loss from a result of class classification performed by the class classifier on at least some of a plurality of first transformed data sets obtained after the data transformation (S12).

Further, the data transformation apparatus 1 calculates an upper bound and a lower bound of a domain classification loss from a result of domain identification performed by the domain classifier on each of the plurality of first transformed data sets (S13).

After Steps S12 and S13, the data transformation apparatus 1 performs learning by updating a parameter of the domain classifier so that the upper bound is reduced and updating a parameter of the data transformer so that the class classification loss is reduced and the lower bound is increased (S14).

As described above, the data transformation apparatus 1 according to this example embodiment performs data transformation on each of a plurality of data sets, and calculates upper and lower bounds of the class classification loss and the domain classification loss for the data sets obtained after the data transformation. Then, the data transformation apparatus 1 trains the data transformation means and the domain classification means so that the upper bounds of the class classification loss and the domain classification loss are reduced. In addition, the data transformation apparatus 1 trains the data transformation means so that the lower bound of the domain classification loss is increased. After that, the data transformation apparatus 1 can perform data transformation on each of the plurality of data sets by the trained data transformation means. That is, the data transformation unit 11 can perform data transformation again on each of the plurality of data sets by using the parameter obtained after the first learning. In other words, the data transformation apparatus 1 can perform data transformation on each of the plurality of input data sets by the data transformer in which the trained parameter is set. Therefore, it becomes easy to flexibly change a loss function in accordance with a problem without depending on a specific loss function, and it is thus possible to improve the accuracy of data transformation for bringing the data distributions among a plurality of data sets belonging to domains different from each other close to each other.

Note that the data transformation apparatus 1 includes, as a configuration that is not shown, a processor, a memory, and a storage device. Further, a computer program in which processing of the data transformation method according to this example embodiment is implemented is stored in the storage device. Further, the processor loads the computer program from the storage device into the memory and executes the loaded computer program. In this way, the processor implements the functions of the data transformation unit 11, the first calculation unit 12, the second calculation unit 13, and the first learning unit 14.

Alternatively, each of the data transformation unit 11, the first calculation unit 12, the second calculation unit 13, and the first learning unit 14 may be implemented by dedicated hardware. Further, some or all of the components of each apparatus may be implemented by a general-purpose or dedicated circuit (circuitry), a processor or the like, or a combination thereof. They may be formed of a single chip, or may be formed of a plurality of chips connected to each other through a bus. Some or all of the components of each apparatus may be implemented by a combination of the above-described circuit or the like and a program. Further, as the processor, a Central Processing Unit (CPU), a Graphics Processing Unit (GPU), a field-programmable gate array (FPGA) or the like may be used.

Further, when some or all of the components of the data transformation apparatus 1 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a client-server system, a cloud computing system, or the like, or a configuration in which the apparatuses or the like are connected to each other through a communication network. Alternatively, the functions of the data transformation apparatus 1 may be provided in the form of Software as a Service (SaaS).

### Second Example Embodiment

A second example embodiment is an improved example of the above-described first example embodiment.

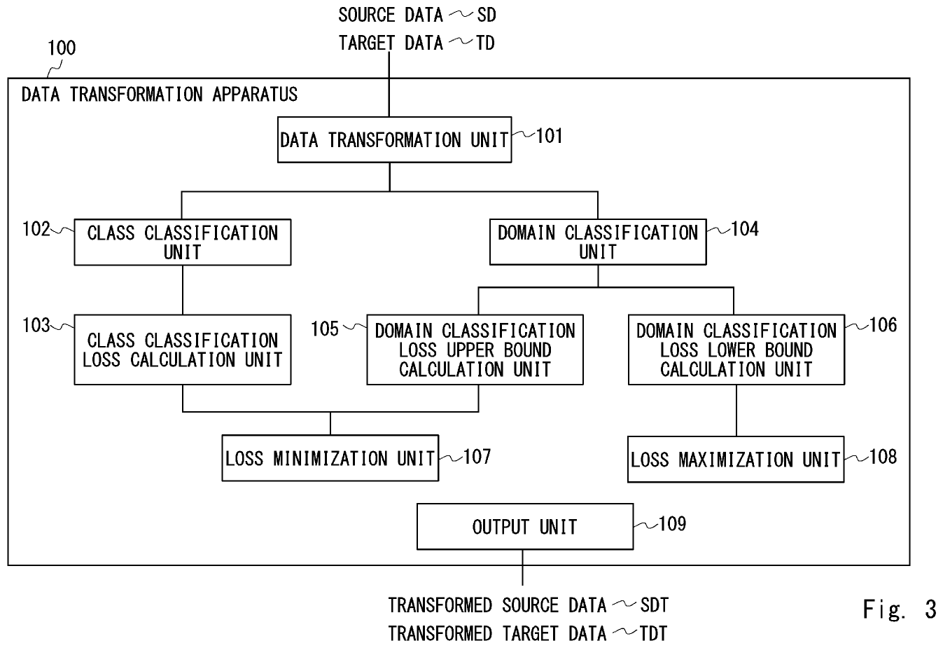

FIG. 3 is a block diagram showing a configuration of a data transformation apparatus 100 according to the second example embodiment. The data transformation apparatus 100 is one example of the data transformation apparatus 1 described above. In the following description, a pattern is denoted by x, a class to which the pattern belongs is denoted by y, and a domain to which the pattern belongs is denoted by d. It is assumed that the number of classes is C of y=1, . . . , C, and the number of domains is two, i.e., a source domain and a target domain. Regarding the source domain, N sets of (x, y) are given, which are referred to as source data SD. Further, the target domain includes M unlabeled x, which are referred to as target data TD. Note that each of the source data SD and the target data TD is an example of the data set described above.

It is assumed that each of the data transformer, the class classifier, and the domain classifier are all implemented by using a neural network, and respective networks are denoted by NN_{f}, NN_{c}, and NN_{d}. Further, a parameter of the data transformation neural network NN_{f} is defined as θ_{f}, a parameter of the class classification neural network NN_{c} is defined as θ_{c}, and a parameter of the domain classification neural network NN_{d} is defined as Od. In this example embodiment, although the same data transformer is used for the source data SD and the target data TD, a different data transformer for each domain may instead be used. Further, the data transformer, the class classifier, and the domain classifier are not limited to being implemented by a neural network, and a method (e.g., a linear transformation and a kernel classifier) generally used in machine learning may instead be used.

Here, the data transformation apparatus 100 receives inputs of the source data SD and the target data TD and performs learning described later. By doing so, after the transformation is performed, NN_{f} which achieves data transformation satisfying a property that the distributions of the source data SD and the target data TD are sufficiently close to each other and the class classification of the source data SD can be performed with high accuracy is acquired by the learning. Then the data transformation apparatus 100 transforms the source data SD and the target data TD by using the trained data transformer (NN_{f}), and outputs the transformed source data SDT and the transformed target data TDT.

In this example embodiment, it is assumed that the number of target data TD is smaller than the number of source data SD (M<N). According to this example embodiment, a loss (specifically, an AUC loss) that can be efficiently learned even in such an unbalanced situation can be used for learning of the domain classifier, and data transformation having the above-described desirable property can be effectively learned.

The data transformation apparatus 100 includes a data transformation unit 101, a class classification unit 102, a class classification loss calculation unit 103, a domain classification unit 104, a domain classification loss upper bound calculation unit 105, a domain classification loss lower bound calculation unit 106, a loss minimization unit 107, a loss maximization unit 108, and an output unit 109. Note that the data transformation unit 101 is an example of the data transformation unit 11 described above. Further, the class classification loss calculation unit 103 is an example of the first calculation unit 12 described above. Further, each of the domain classification loss upper bound calculation unit 105 and the domain classification loss lower bound calculation unit 106 is an example of the second calculation unit 13 described above. Further, each of the loss minimization unit 107 and the loss maximization unit 108 is an example of the first learning unit 14 described above.

The data transformation unit 101 performs data transformation on samples randomly extracted from the source data SD and the target data TD by using the data transformation neural network NN_{f}. That is, the data transformation unit 101 performs data transformation on at least part of the source data SD by using the data transformation neural network NN_{f}. Further, the data transformation unit 101 performs data transformation on at least part of the target data TD by using the data transformation neural network NN_{f}. Then the data transformation unit 101 outputs the source data obtained after the data transformation to the class classification unit 102 and the domain classification unit 104, and outputs the target data obtained after the data transformation to at least the domain classification unit 104. In this case, the data obtained after the data transformation is NN_{f}(x; θ_{f}).

The class classification unit 102 uses source data on which the data transformation unit 101 has performed the data transformation as an input, and distinguishes classes to which the respective data pieces belong by using the class classification neural network NN_{c}. Note that when the label of the target data is provided, the target data obtained after the data transformation may be used as an input, and further, both the source data and the target data obtained after the data transformation may be used as inputs.

It is assumed here that the class classification neural network NN_{c}, like in a case in which it is commonly used as a neural network for classifying classes, outputs a posterior probability p (y|x) for each class. In this case, a result of the class classification is NN_{c}(NN_{f}(x; θ_{f}); θ_{c}).

The class classification loss calculation unit 103 uses the result of the class classification calculated by the class classification unit 102 as an input and calculates a loss with regard to the result of the class classification. In this example embodiment, a cross entropy loss commonly used as a loss of class classification is used. When it is assumed that a class classification loss is L_{c}, L_{c} obtained when the cross entropy loss is used is defined by the following Expression (1).

$$\begin{matrix}[ Expression 1 ] & \\ {L}_{c} ( x , y , {θ}_{f} , {θ}_{c} ) = - {\sum }_{i = 1}^{c} H ( y = i ) log {NN}_{c}^{( i )} ( {NN}_{f} ( x ; {θ}_{f} ) ; {θ}_{c} ) & ( 1 )\end{matrix}$$

where H(*) is an indicator function that receives 1 if the argument is true and 0 if the argument is false, and NN_{c}⁽ⁱ⁾ is the output of NN_{c} corresponding to the i-th class.

The domain classification unit 104 uses source data and target data on which the data transformation unit 101 has performed the data transformation as inputs, and distinguishes domains to which the respective data pieces belong by using the domain classification neural network NN_{d}. In this case, the output of NN_{d} is NN_{d}(NN_{f}(x; θ_{f}); θ_{d}). Since there are two types of domains, which are a source domain and a target domain, NN_{d} is a neural network that performs two-class classification. In this example embodiment, the output of NN_{d} is a score indicating the possibility that the input data belongs to the target domain. That is, when the probability that the data belongs to the target domain is high, the score is high, while when the probability that the data belongs to the source domain is high, the score is low.

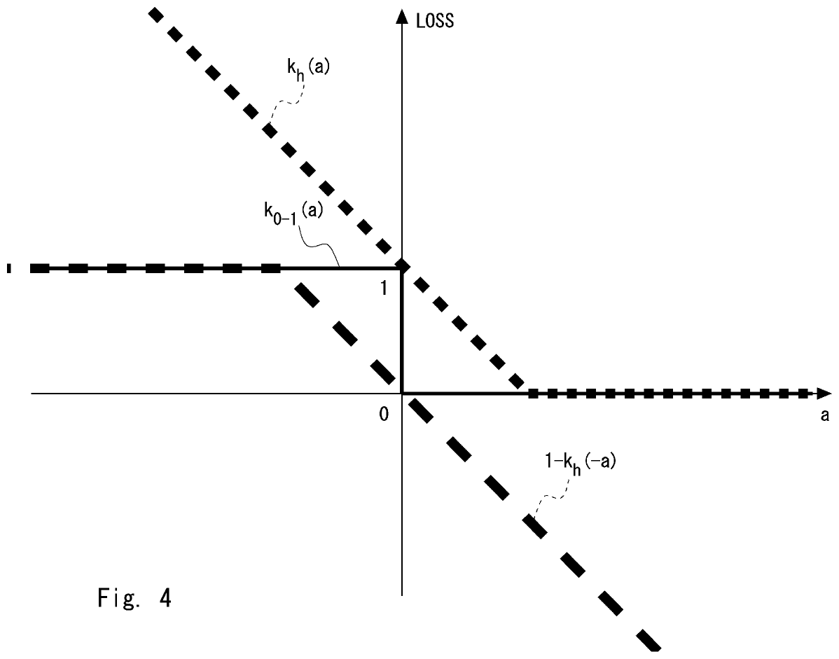

The domain classification loss upper bound calculation unit 105 uses the result of the domain classification calculated by the domain classification unit 104 as an input and calculates an upper bound of a loss with regard to the result of the domain classification. In this example embodiment, since the number of target data is much smaller than the number of source data, the AUC loss robust to learning of such imbalanced data is used as a domain classification loss. When it is assumed that the sample extracted from the target data is x and the sample extracted from the source data is x′, the AUC loss is defined by the following Expression (2).

$$\begin{matrix}[ Expression 2 ] & \\ {L}_{d} ( x , {x}^{′} , {θ}_{f} , {θ}_{d} ) = {k}_{0 - 1} ( {NN}_{d} ( {NN}_{f} ( x ; {θ}_{f} ) ; {θ}_{d} ) - {NN}_{d} ( {NN}_{f} ( {x}^{′} ; {θ}_{f} ) ; {θ}_{d} ) ) & ( 2 )\end{matrix}$$

where k₀₋₁(a) is a 0-1 loss function which becomes 1 when a<0, and 0 when a>=0. In this example embodiment, in order to calculate the upper bound of the domain classification loss, the upper bound L^{u}_{d} of the AUC loss is defined by the following Expression (3) using a hinge loss function.

$$\begin{matrix}[ Expression 3 ] & \\ {L}_{d}^{u} ( x , {x}^{′} , {θ}_{f} , {θ}_{d} ) = {k}_{h} ( {NN}_{d} ( {NN}_{f} ( x ; {θ}_{f} ) ; {θ}_{d} ) - {NN}_{d} ( {NN}_{f} ( {x}^{′} ; {θ}_{f} ) ; {θ}_{d} ) ) & ( 3 )\end{matrix}$$

where kₕ(a) is a hinge function which becomes 1−a when a<1, and 0 when a>=1. As shown in FIG. 4, L^{u}_{d} is the upper bound of the AUC loss since the hinge loss function does not receive a value less than that of the 0-1 loss function.

The domain classification loss lower bound calculation unit 106 uses the result of the domain classification calculated by the domain classification unit 104 as an input and calculates a lower bound of a loss with regard to the result of the domain classification. In this example embodiment, the lower bound L^{l}_{d} of the AUC loss is defined by the following Expression (4) using a hinge loss function.

$$\begin{matrix}[ Expression 4 ] & \\ {L}_{d}^{l} ( x , {x}^{′} , {θ}_{f} , {θ}_{d} ) = 1 - {k}_{h} ( - ( {NN}_{d} ( {NN}_{f} ( x ; {θ}_{f} ) ; {θ}_{d} ) - {NN}_{d} ( {NN}_{f} ( {x}^{′} ; {θ}_{f} ) ; {θ}_{d} ) ) ) & ( 4 )\end{matrix}$$

As shown in FIG. 4, L^{l}_{d} is the lower bound of the AUC loss since 1−kₕ(−a) does not receive a value greater than that of the 0-1 loss function.

It may not be necessary to express the upper bound of the loss and the lower bound of the loss using a hinge function. The upper bound of the loss may be, for example, a function in which the loss when the value of a is 0 is 1 (i.e., it coincides with the value of the 0-1 loss function), the value converges to 0 as the value of a increases, and the value increases as the value of a is reduced. Further, the lower bound of the loss may be, for example, a function in which the loss when the value of a is 0 is 0 (i.e., it coincides with the value of the 0-1 loss function), the value converges to 1 as the value of a is reduced, and the value is reduced as the value of a increases. Further, it may not be necessary to express the upper bound of the loss and the lower bound of the loss by one function (e.g., the hinge loss function). For example, a function representing the upper bound of the loss and a function representing the lower bound of the loss may be expressed by using different functions. As shown in Expressions (3) and (4), by expressing the function representing the upper bound of the loss and the function representing the lower bound of the loss by using one function (e.g., the hinge loss function), it is possible to provide an effect that the processing performed by the domain classification loss lower bound calculation unit 106 and the domain classification loss upper bound calculation unit 105 can be implemented by using one function (a function for calculating the hinge loss function).

The loss minimization unit 107 updates, by using the class classification loss calculated by the class classification loss calculation unit 103 and the domain classification loss upper bound value calculated by the domain classification loss upper bound calculation unit 105, the parameters of the data transformer, the class classifier, and the domain classifier so that these losses are minimized. In this example embodiment, as a method for updating a parameter, a stochastic gradient descent method which is commonly used for learning of a neural network is used. At this time, the loss minimization unit updates the parameter as shown in the following Expressions (5-1) to (5-3).

$$\begin{matrix}[ Expression 5 ] & \\ {θ}_{f} ← {θ}_{f} - μ \frac{\partial {L}_{c}}{\partial {θ}_{f}} & ( 5 \text{-} 1 ) \\ {θ}_{c} ← {θ}_{c} - μ \frac{\partial {L}_{c}}{\partial {θ}_{c}} & ( 5 \text{-} 2 ) \\ {θ}_{d} ← {θ}_{d} - μ \frac{\partial {L}_{d}^{u}}{\partial {θ}_{d}} & ( 5 \text{-} 3 )\end{matrix}$$

where μ is a predetermined learning coefficient.

The loss maximization unit 108 updates, by using the domain classification loss lower bound value calculated by the domain classification loss lower bound calculation unit 106, the parameter of the data transformer so that the calculated value is maximized. When the stochastic gradient descent method is used in a manner similar to that in the loss minimization unit 107, the parameter is updated as shown in the following Expression (6).

$$\begin{matrix}[ Expression 6 ] & \\ {θ}_{f} ← {θ}_{f} + μ \frac{\partial {L}_{d}^{l}}{\partial {θ}_{f}} & ( 6 )\end{matrix}$$

Note that it can be considered that the loss minimization unit 107 and the loss maximization unit 108 have further updated the parameters of the class classification means so that the class classification loss is minimized in the first learning in the first example embodiment described above.

Further, it can be considered that the loss minimization unit 107 and the loss maximization unit 108 use, in the first learning of the domain classification means, the Area Under the Curve (AUC) for the first learning means according to the first example embodiment described above.

The data transformation apparatus 100 performs parameter learning (first learning) by repeating processing from data transformation to updating of a parameter. The parameters of the data transformation unit 101, the class classification unit 102, and the domain classification unit 104 are updated by the learning.

The data transformation unit 101 determines that, when the learning of the parameter satisfies predetermined conditions, the learning has converged, and performs data transformation on each of the source data SD and the target data TD again. At this time, as the parameter of the data transformation unit 101, the parameter after the learning has converged is used. Note that the predetermined conditions are, for example, the number of repetitions and the upper limit value of the processing time, but are not limited thereto.

The output unit 109 is an example of first output means for outputting a plurality of second transformed data sets on which the data transformation unit 101 has performed the data transformation again using the trained parameter. In this example embodiment, the output unit 109 outputs the transformed source data SDT and the transformed target data TDT, which have been subjected to the data transformation by the trained NN_{f}, as a plurality of second transformed data sets. Note that the output unit 109 may be second output means for outputting the trained parameter of the data transformation unit 101. Further, the output unit 109 may be third output means for outputting the class classification unit 102 in which the trained parameter of the class classification unit 102 is set. Further, the output unit 109 may be any means that has some or all of the functions of the first output means, the second output means, and the third output means.

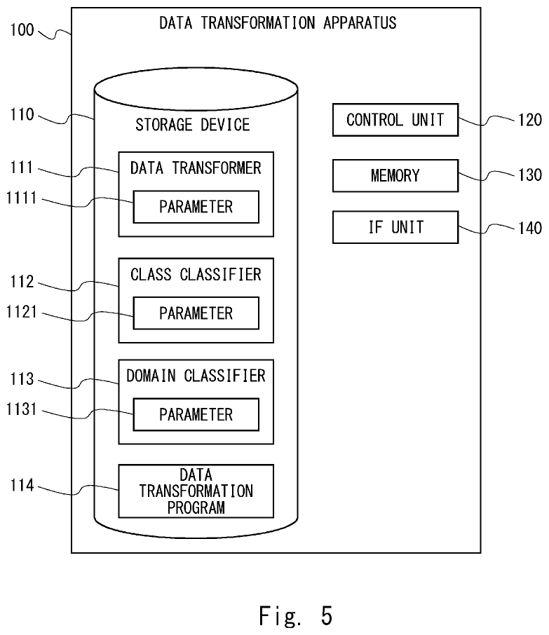

FIG. 5 is a block diagram showing a hardware configuration of the data transformation apparatus 100 according to the second example embodiment. The data transformation apparatus 100 includes a storage device 110, a control unit 120, a memory 130, and an InterFace (IF) unit 140. The storage device 110 is a non-volatile storage device such as a hard disk, a flash memory, or the like. The storage device 110 stores a data transformer 111, a class classifier 112, a domain classifier 113, and a data transformation program 114.

The data transformer 111 is a program module or a model formula in which processing for transforming each data from an input data set into another data set is implemented. For example, the data transformer 111 is a mathematical model calculated by using a plurality of data randomly sampled from the source data SD as input data and using a predetermined parameter 1111 (a weighting coefficient) for each input data. Note that although the data transformer 111 corresponds to the data transformation neural network NN_{f} in the description of this example embodiment, it is not limited thereto, and it may be represented by a support vector machine or the like.

The class classifier 112 is a program module or a model formula in which processing for distinguishing to which class at least part of data of the input data set belongs is implemented. For example, the class classifier 112 is a mathematical model calculated by using each data of the data sets obtained by the data transformation performed on the source data SD by the data transformer 111 as input data and using a predetermined parameter 1121 for each input data. Note that although the class classifier 112 corresponds to the class classification neural network NN_{c} in the description of this example embodiment, it is not limited thereto, and it may be represented by a support vector machine or the like.

The domain classifier 113 is a program module or a model formula in which processing for distinguishing to which domain the input data set belongs is implemented. For example, the domain classifier 113 is a mathematical model calculated by using each data of the data sets obtained by the data transformation performed on the source data SD and the target data TD by the data transformer 111 as input data and using a predetermined parameter 1131 for each input data. Note that although the domain classifier 113 corresponds to the domain classification neural network NN_{d} in the description of this example embodiment, it is not limited thereto, and it may be represented by a support vector machine or the like.

The data transformation program 114 is a computer program in which processing of the data transformation method according to this example embodiment is implemented.

The memory 130, which is a volatile storage device such as a Random Access Memory (RAM), is a storage area for temporarily holding information when the control unit 120 is operated. The IF unit 140 is an interface that receives/outputs data from/to the outside of the data transformation apparatus 100. For example, the IF unit 140 outputs input data from the outside to the control unit 120, and outputs data received from the control unit 120 to the outside.

The control unit 120 is a processor that controls each component of the data transformation apparatus 100, that is, a control apparatus. The control unit 120 loads the data transformation program 114 into the memory 130 from the storage device 110 and executes the data transformation program 114. Further, the control unit 120 loads the data transformer 111, the class classifier 112, and the domain classifier 113 from the storage device 110 into the memory 130 and executes them as appropriate. By doing so, the control unit 120 implements the functions of the data transformation unit 101, the class classification unit 102, the class classification loss calculation unit 103, the domain classification unit 104, the domain classification loss upper bound calculation unit 105, the domain classification loss lower bound calculation unit 106, the loss minimization unit 107, the loss maximization unit 108, and the output unit 109. Further, the control unit 120 updates the parameters 1111, 1121, and 1131 in the storage device 110 in accordance with the learning.

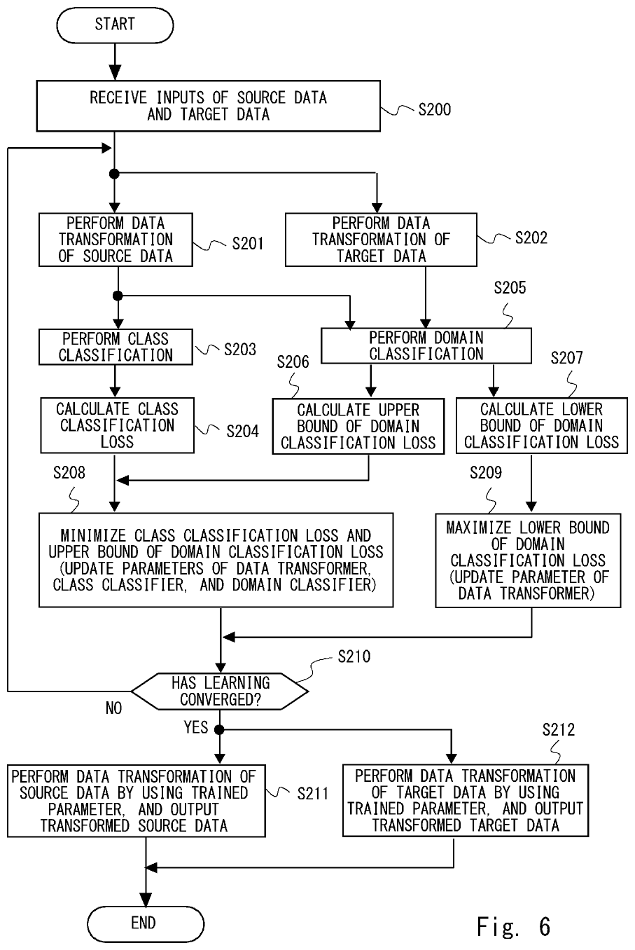

FIG. 6 is a flowchart showing a flow of the data transformation method according to the second example embodiment. First, the data transformation apparatus 100 receives inputs of the source data SD and the target data TD (S200). Then, the data transformation unit 101 performs data transformation of the source data SD by the data transformation neural network NN_{f} (S201). Further, the data transformation unit 101 performs data transformation of the target data TD by the data transformation neural network NN_{f} (S202).

After Step S201, the class classification unit 102 performs, by the class classification neural network NN_{c}, class classification on each data of the data sets obtained by performing the data transformation on the source data SD (S203).

Further, after Steps S201 and S202, the domain classification unit 104 performs, by the domain classification neural network NN_{d}, domain classification on each data set obtained by performing the data transformation on the source data SD and the target data TD (S205).

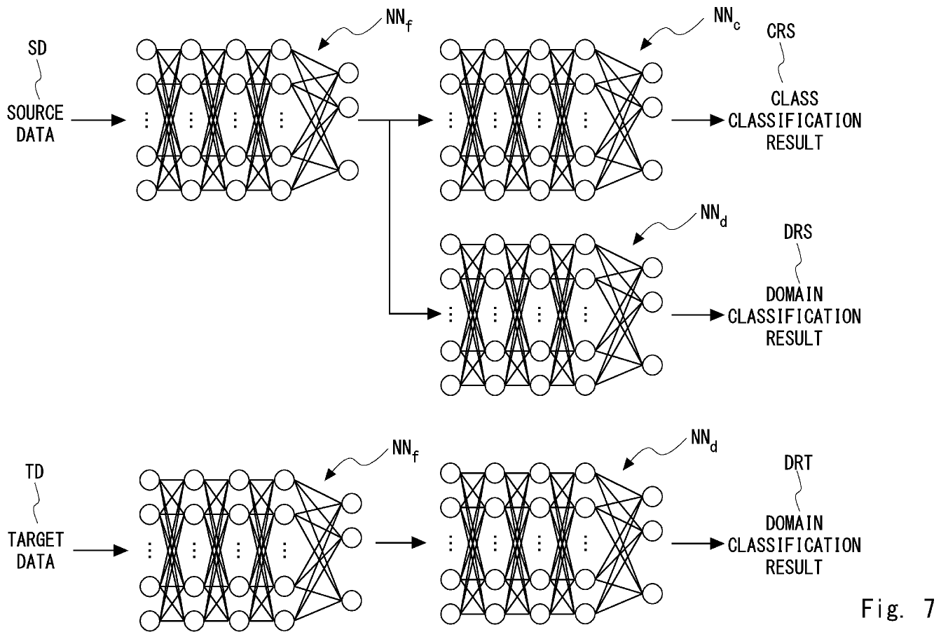

Here, FIG. 7 is a diagram for explaining a relation among the source data and the target data and the data transformer, the class classifier, and the domain classifier according to the second example embodiment. As described above, the source data SD is input to the data transformation neural network NN_{f}, and the transformed data set is output to the class classification neural network NN_{c} and the domain classification neural network NN_{d}. As a result, the class classification neural network NN_{c} outputs a class classification result CRS, and the domain classification neural network NN_{d} outputs a domain classification result DRS. Further, the target data TD is input to the data transformation neural network NN_{f}, and the transformed data set is output to the domain classification neural network NN_{d}. As a result, the domain classification neural network NN_{d} outputs a domain classification result DRT.

Referring back to FIG. 6, the description will be continued. After Step S203, the class classification loss calculation unit 103 calculates a class classification loss from the class classification result CRS (S204).

Further, after Step S205, the domain classification loss upper bound calculation unit 105 calculates an upper bound of the domain classification loss from the domain classification results DRS and DRT (S206). In addition, the domain classification loss lower bound calculation unit 106 calculates a lower bound of domain classification loss from the domain classification results DRS and DRT (S207).

After Steps S204 and S206, the loss minimization unit 107 minimizes the class classification loss and the upper bound of the domain classification loss (S208). That is, the loss minimization unit 107 updates the parameters of the data transformer 111, the class classifier 112, and the domain classifier 113 as described above.

Further, after Step S207, the loss maximization unit 108 maximizes the lower bound of the domain classification loss (S209). That is, the loss maximization unit 108 updates the parameter of the data transformer 111 as described above.

After Steps S208 and S209, the data transformation apparatus 100 determines whether or not the learning of the loss minimization unit 107 and the loss maximization unit 108 has converged (S210). That is, the data transformation apparatus 100 determines whether or not the learning satisfies predetermined conditions.

If the learning does not satisfy the predetermined conditions, the process returns to Steps S201 and S202, and the processing is repeated until the learning converges. If the learning satisfies the predetermined conditions, the data transformation unit 101 performs data transformation of the source data SD by using the trained parameter. Then the output unit 109 outputs the transformed source data SDT (S211). In addition, the data transformation unit 101 performs data transformation of the target data TD by using the trained parameter. Then the output unit 109 outputs the transformed target data TDT (S212).

As described above, this example embodiment is intended for a case in which data is transformed so that the distribution of data in one domain (a source domain) is brought close to the distribution of data in another domain (a target domain) in a situation where the distribution of data is different for each domain to which the data belongs. In this example embodiment, even when an index which it is difficult to directly optimize is used as an index for measuring the closeness between data distributions, it is possible to perform appropriate and efficient data transformation. For example, in domain adaptation based on adversarial learning, an evaluation index which it is difficult to directly optimize can be used as a domain classification loss so that it can be introduced into adversarial learning, whereby flexible change of a loss function in accordance with problems can be enabled. Therefore, even when an evaluation index which it is difficult to directly optimize is used as a domain classification loss, it is possible to efficiently perform adversarial learning and learn data transformation. In other words, in this example embodiment, in adversarial learning of data transformation, instead of performing maximization and minimization on a single loss, an upper bound value of a loss is minimized when minimization is performed, and a lower bound value of a loss is maximized when maximization is performed. By this configuration, even when it is difficult to directly optimize the original loss, it is possible to efficiently achieve adversarial learning by using instead the upper and the lower bound values that can be efficiently optimized.

### Third Example Embodiment

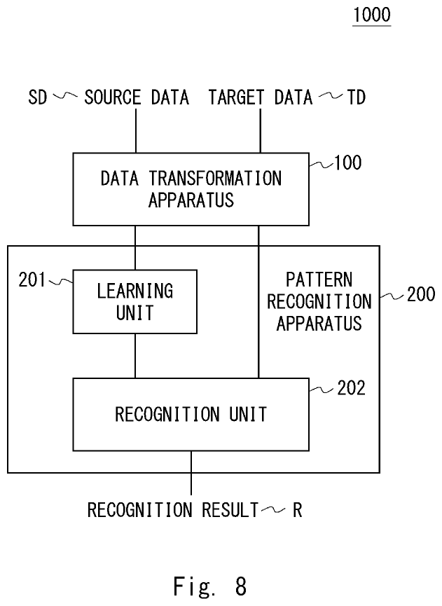

A third example embodiment is a specific example embodiment using the data transformation apparatus 100 according to the second example embodiment. FIG. 8 is a block diagram showing a configuration of a pattern recognition system 1000 according to the third example embodiment. The pattern recognition system 1000 is an information system including the data transformation apparatus 100 and a pattern recognition apparatus 200. Note that, in the pattern recognition system 1000, the data transformation apparatus 100 and the pattern recognition apparatus 200 may be implemented by being integrated into one computer or being distributed among a plurality of computers for each function. The pattern recognition system 1000 is used for application purposes such as image recognition and voice recognition. However, the pattern recognition system 1000 may instead be used for application purposes other than the above ones. Here, the data transformation apparatus 100 performs feature transformation (data transformation) on the input source data SD (training data) and the target data TD (test data). Then the data transformation apparatus 100 outputs the transformed source data SDT to a learning unit 201 described later and the transformed target data TDT to a recognition unit 202 described later. The configurations of the data transformation apparatus 100 other than those described above are similar to those of the data transformation apparatus 100 according to the second example embodiment described above, and thus detailed descriptions thereof will be omitted.

The pattern recognition apparatus 200 includes a pattern recognition model trained by using a plurality of second transformed data sets output by the output unit 109 according to the second embodiment described above. The pattern recognition apparatus 200 includes the learning unit 201 and the recognition unit 202.

On the basis of the training data (the transformed source data SDT) on which the data transformation apparatus 100 has performed the data transformation, the learning unit 201 trains the recognition model based on, for example, a support vector machine and a neural network. The learning unit 201 is an example of second learning means for performing second learning of a pattern recognition model by using a plurality of second transformed data sets obtained by the data transformation performed again on each of the plurality of data sets by the data transformation means in which the parameter obtained after the first learning is set.

The recognition unit 202 recognizes the test data (the transformed target data TDT) on which the data transformation apparatus 100 has performed data transformation by using the recognition model trained by the learning unit 201. The recognition unit 202 outputs a recognition result R to, for example, any type of storage means and communication network or any type of display means (not shown). The recognition unit 202 is an example of recognition means for performing pattern recognition on predetermined data using a pattern recognition model in which the parameter obtained after the second learning is set.

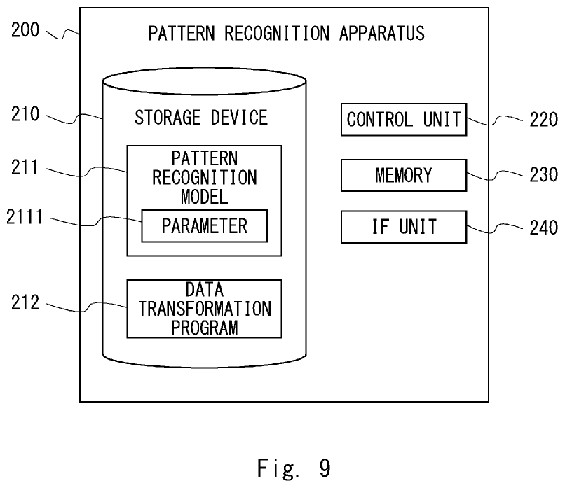

FIG. 9 is a block diagram showing a hardware configuration of the pattern recognition apparatus 200 according to the third example embodiment. The pattern recognition apparatus 200 is an information processing apparatus including a storage device 210, a control unit 220, a memory 230, and an IF unit 240. The storage device 210 is a non-volatile storage device such as a hard disk, a flash memory, or the like. The storage device 210 stores a pattern recognition model 211 and a pattern recognition program 212.

The pattern recognition model 211 is a program module or a model formula in which processing for recognizing a pattern and outputting a result of the recognition from an input data set (feature information) is implemented. For example, the pattern recognition model 211 is a mathematical model calculated by using the transformed target data TDT as input data and using a predetermined parameter 2111 for each input data.

The pattern recognition program 212 is a computer program in which processing including pattern recognition according to this example embodiment is implemented.

The memory 230, which is a volatile storage device such as a Random Access Memory (RAM), is a storage area for temporarily holding information when the control unit 220 is operated. The IF unit 240 is an interface that receives/outputs data from/to the outside of the pattern recognition apparatus 200. For example, the IF unit 240 outputs input data from the data transformation apparatus 100 to the control unit 220, and outputs data received from the control unit 220 to the outside.

The control unit 220 is a processor that controls each component of the pattern recognition apparatus 200, that is, a control apparatus. The control unit 220 loads the pattern recognition program 212 into the memory 230 from the storage device 210 and executes the pattern recognition program 212. Further, the control unit 220 loads the pattern recognition model 211 from the storage device 210 into the memory 230 and executes it as appropriate. By doing so, the control unit 220 implements the functions of the learning unit 201 and the recognition unit 202. Further, the control unit 220 updates the parameter 2111 in the storage device 210 in accordance with the learning.

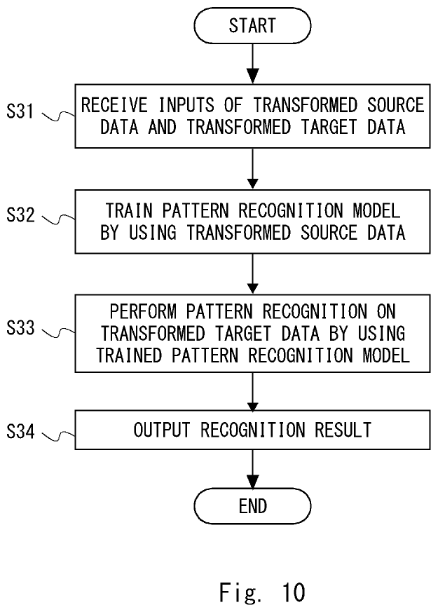

FIG. 10 is a flowchart showing a flow of pattern recognition processing according to the third example embodiment. Note that, it is assumed that the data transformation processing shown in FIG. 6 has already been executed. First, the pattern recognition apparatus 200 receives inputs of the transformed source data SDT and the transformed target data TDT from the data transformation apparatus 100 (S31). The source data and the target data are, for example, feature vectors extracted from image information or feature vectors extracted from voice information. The pattern recognition apparatus 200 is, for example, an apparatus that determines whether or not image information includes a detection target, or an apparatus that specifies a speaker of voice information.

Next, the learning unit 201 trains the pattern recognition model 211 by using the transformed source data SDT (S32). After that, the recognition unit 202 performs pattern recognition on the transformed target data TDT by using the trained pattern recognition model 211 (S33). Then the recognition unit 202 outputs the recognition result R (S34).

As described above, in the pattern recognition system 1000 according to the third example embodiment, the learning unit 201 performs learning of the recognition model based on the training data on which the data transformation apparatus 100 has performed data transformation. Thus, the pattern recognition apparatus 200 according to this example embodiment can generate a highly accurate recognition model even when the distribution of training data prepared in advance is different from the distribution of test data. Therefore, for example, in a case in which the pattern recognition system 1000 according to this example embodiment is used for recognition of an image or a voice, the pattern recognition system 1000 can perform recognition and the like with high accuracy when a recognition model generated based on training data prepared in advance is applied to actual test data.

### Other Example Embodiments

Note that, when the output unit 109 according to the second example embodiment outputs a trained class classifier, the pattern recognition apparatus 200 according to the third example embodiment may use the trained class classifier as a pattern recognition model.

Note that, in the above-described example embodiments, each element illustrated in the drawings as a functional block that performs various kinds of processing may be configured by a Central Processing Unit (CPU), a memory, and other circuits in terms of hardware, and is implemented by a program etc. loaded by the CPU in a memory and executed by the CPU in terms of software. Therefore, it will be understood by those skilled in the art that these functional blocks can be implemented in various forms by only hardware, only software, or a combination thereof, and the present disclosure is not limited to any of them.

The above program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-Recordable (CD-R), CD-ReWritable (CD-R/W), and semiconductor memories (such as mask ROM, Programmable ROM (PROM), Erasable PROM (EPROM), flash ROM, Random Access Memory (RAM), etc.). Further, the program(s) be provided to a computer using any type of transitory computer readable media. Examples of transitory computer readable media include electric signals, optical signals, and electromagnetic waves. Transitory computer readable media can provide the program(s) to a computer via a wired communication line (e.g., electric wires, and optical fibers) or a wireless communication line.

Note that the present disclosure is not limited to the above example embodiments and may be changed as appropriate without departing from the spirit of the present disclosure. Further, the present disclosure may be executed by combining the example embodiments as appropriate.

The whole or part of the example embodiments disclosed above can be described as, but not limited to, the following supplementary notes.

(Supplementary Note A1)

A data transformation apparatus comprising:

data transformation means for performing data transformation on each of a plurality of data sets belonging to domains different from each other so that data distributions of the plurality of data sets are brought close to each other;

first calculation means for calculating a class classification loss from a result of class classification performed by class classification means on at least some of a plurality of first transformed data sets obtained after the data transformation;

second calculation means for calculating an upper bound and a lower bound of a domain classification loss from a result of domain classification performed by domain classification means on each of the plurality of first transformed data sets; and

first learning means for performing first learning by updating a parameter of the domain classification means so that the upper bound is reduced and updating a parameter of the data transformation means so that the class classification loss is reduced and the lower bound is increased.

(Supplementary Note A2)

The data transformation apparatus according to Supplementary Note A1, further comprising first output means for outputting a plurality of second transformed data sets on which the data transformation means has performed the data transformation again by using the parameter obtained after the first learning.

(Supplementary Note A3)

The data transformation apparatus according to Supplementary Note A1 or A2, further comprising second output means for outputting the parameter of the data transformation means obtained after the first learning.

(Supplementary Note A4)

The data transformation apparatus according to any one of Supplementary Notes A1 to A3, wherein

the first learning means further updates, in the first learning, a parameter of the class classification means so that the class classification loss is minimized, and

the data transformation apparatus further comprises third output means for outputting the class classification means in which the parameter of the class classification means obtained after the first learning is set.

(Supplementary Note A5)

The data transformation apparatus according to any one of Supplementary Notes A1 to A4, wherein the first learning means uses an Area Under the Curve (AUC) in the first learning of the domain classification means.

(Supplementary Note A6)

The data transformation apparatus according to any one of Supplementary Notes A1 to A5, wherein the plurality of data sets include a source data set belonging to a source domain and a target data set belonging to a target domain.

(Supplementary Note A7)

A pattern recognition apparatus comprising a pattern recognition model trained by using the plurality of second transformed data sets output by the first output means according to Supplementary Note A2.

(Supplementary Note A8)

A pattern recognition apparatus comprising:

second learning means for performing second learning of a pattern recognition model by using the plurality of second transformed data sets output by the first output means according to Supplementary Note A2; and

recognition means for performing pattern recognition on a data set input by using the pattern recognition model in which the parameter obtained after the second learning is set.

(Supplementary Note A9)

A pattern recognition apparatus comprising the class classification means output by the third output means according to Supplementary Note A4 as a pattern recognition model.

(Supplementary Note B1)

A pattern recognition system comprising:

data transformation means for performing data transformation on each of a plurality of data sets belonging to domains different from each other so that data distributions of the plurality of data sets are brought close to each other;

first calculation means for calculating a class classification loss from a result of class classification performed by class classification means on at least some of a plurality of first transformed data sets obtained after the data transformation;

second calculation means for calculating an upper bound and a lower bound of a domain classification loss from a result of domain classification performed by domain classification means on each of the plurality of first transformed data sets;

first learning means for performing first learning by updating a parameter of the domain classification means so that the upper bound is reduced and updating a parameter of the data transformation means so that the class classification loss is reduced and the lower bound is increased;

second learning means for performing second learning of a pattern recognition model by using a plurality of second transformed data sets obtained by the data transformation performed again on each of the plurality of data sets by the data transformation means in which the parameter obtained after the first learning is set; and

recognition means for performing pattern recognition on a data set input by using the pattern recognition model in which the parameter obtained after the second learning is set.

(Supplementary Note B2)

The pattern recognition system according to Supplementary Note B1, wherein the first learning means uses an Area Under the Curve (AUC) in the first learning of the domain classification means.

(Supplementary Note C1)

A data transformation method comprising:

performing, by a computer, data transformation using a data transformer on each of a plurality of data sets belonging to domains different from each other so that data distributions of the plurality of data sets are brought close to each other;

calculating, by the computer, a class classification loss from a result of class classification performed by a class classifier on at least some of a plurality of first transformed data sets obtained after the data transformation;

calculating, by the computer, an upper bound and a lower bound of a domain classification loss from a result of domain classification performed by a domain classifier on each of the plurality of first transformed data sets; and

performing, by the computer, learning by updating a parameter of the domain classifier so that the upper bound is reduced and updating a parameter of the data transformer so that the class classification loss is reduced and the lower bound is increased.

(Supplementary Note D1)

A non-transitory computer readable medium storing a data transformation program for causing a computer to execute:

data transformation processing for performing data transformation using a data transformer on each of a plurality of data sets belonging to domains different from each other so that data distributions of the plurality of data sets are brought close to each other;

first calculation processing for calculating a class classification loss from a result of class classification performed by a class classifier on at least some of a plurality of first transformed data sets obtained after the data transformation;

second calculation processing for calculating an upper bound and a lower bound of a domain classification loss from a result of domain classification performed by a domain classifier on each of the plurality of first transformed data sets; and

learning processing for performing learning by updating a parameter of the domain classifier so that the upper bound is reduced and updating a parameter of the data transformer so that the class classification loss is reduced and the lower bound is increased.

Although the present disclosure has been described with reference to the example embodiments (and examples), the present disclosure is not limited to the above-described example embodiments (and examples). Various changes that may be understood by those skilled in the art may be made to the configurations and the details of the present disclosure within the scope of the present disclosure.

### REFERENCE SIGNS LIST

1 DATA TRANSFORMATION APPARATUS
11 DATA TRANSFORMATION UNIT
12 FIRST CALCULATION UNIT
13 SECOND CALCULATION UNIT
14 FIRST LEARNING UNIT
100 DATA TRANSFORMATION APPARATUS
101 DATA TRANSFORMATION UNIT
102 CLASS CLASSIFICATION UNIT
103 CLASS CLASSIFICATION LOSS CALCULATION UNIT
104 DOMAIN CLASSIFICATION UNIT
105 DOMAIN CLASSIFICATION LOSS UPPER BOUND CALCULATION UNIT
106 DOMAIN CLASSIFICATION LOSS LOWER BOUND CALCULATION UNIT
107 LOSS MINIMIZATION UNIT
108 LOSS MAXIMIZATION UNIT
109 OUTPUT UNIT
110 STORAGE DEVICE
111 DATA TRANSFORMER
1111 PARAMETER
112 CLASS CLASSIFIER
1121 PARAMETER
113 DOMAIN CLASSIFIER
1131 PARAMETER
114 DATA TRANSFORMATION PROGRAM
120 CONTROL UNIT
130 MEMORY
140 IF UNIT
1000 PATTERN RECOGNITION SYSTEM
200 PATTERN RECOGNITION APPARATUS
201 LEARNING UNIT
202 RECOGNITION UNIT
210 STORAGE DEVICE
211 PATTERN RECOGNITION MODEL
2111 PARAMETER
212 PATTERN RECOGNITION PROGRAM
220 CONTROL UNIT
230 MEMORY
240 IF UNIT
SD SOURCE DATA
TD TARGET DATA
BL CLASS CLASSIFICATION BOUNDARY
MD MISRECOGNITION DATA
SDT TRANSFORMED SOURCE DATA
TDT TRANSFORMED TARGET DATA
BLT CLASS CLASSIFICATION BOUNDARY
CRS CLASS CLASSIFICATION RESULT
DRS DOMAIN CLASSIFICATION RESULT
DRT DOMAIN CLASSIFICATION RESULT
NN_{f} DATA TRANSFORMATION NEURAL NETWORK
NN_{c} CLASS CLASSIFICATION NEURAL NETWORK
NN_{d} DOMAIN CLASSIFICATION NEURAL NETWORK
R RECOGNITION RESULT

What is claimed is:

1. A data transformation apparatus comprising:
at least one memory configured to store instructions, and
at least one processor configured to execute the instructions to:
perform data transformation using a data transformer on each of a plurality of data sets belonging to domains different from each other so that data distributions of the plurality of data sets are brought close to each other;
calculate a class classification loss from a result of class classification performed by a class classifier on at least some of a plurality of first transformed data sets obtained after the data transformation;
calculate an upper bound and a lower bound of a domain classification loss from a result of domain classification performed by a domain classifier on each of the plurality of first transformed data sets; and
perform first learning by updating a parameter of the domain classifier so that the upper bound is reduced and updating a parameter of the data transformer so that the class classification loss is reduced and the lower bound is increased.

2. The data transformation apparatus according to claim 1, wherein the at least one processor further configured to execute the instructions to output a plurality of second transformed data sets on which the data transformer has performed the data transformation again by using the parameter obtained after the first learning.

3. The data transformation apparatus according to claim 1, wherein the at least one processor further configured to execute the instructions to output the parameter of the data transformer obtained after the first learning.

4. The data transformation apparatus according to claim 1, wherein the at least one processor further configured to execute the instructions to
update, in the first learning, a parameter of the class classifier so that the class classification loss is minimized, and
output the class classifier in which the parameter of the class classifier obtained after the first learning is set.

5. The data transformation apparatus according to claim 1, wherein the at least one processor further configured to execute the instructions to use an Area Under the Curve (AUC) in the first learning of the domain classifier.

6. The data transformation apparatus according to claim 1, wherein the plurality of data sets include a source data set belonging to a source domain and a target data set belonging to a target domain.

7. A pattern recognition apparatus comprising a pattern recognition model trained by using the plurality of second transformed data sets output by the data transformation apparatus according to claim 2.

8. A pattern recognition apparatus comprising:
at least one second memory configured to store instructions, and
at least one second processor configured to execute the instructions to:
perform second learning of a pattern recognition model by using the plurality of second transformed data sets output by the data transformation apparatus according to claim 2; and
perform pattern recognition on a data set input by using the pattern recognition model in which the parameter obtained after the second learning is set.

9. A pattern recognition apparatus comprising the class classifier output by the data transformation apparatus according to claim 4 as a pattern recognition model.

10.-11. (canceled)

12. A data transformation method comprising:
performing, by a computer, data transformation using a data transformer on each of a plurality of data sets belonging to domains different from each other so that data distributions of the plurality of data sets are brought close to each other;
calculating, by the computer, a class classification loss from a result of class classification performed by a class classifier on at least some of a plurality of first transformed data sets obtained after the data transformation;
calculating, by the computer, an upper bound and a lower bound of a domain classification loss from a result of domain classification performed by a domain classifier on each of the plurality of first transformed data sets; and
performing, by the computer, learning by updating a parameter of the domain classifier so that the upper bound is reduced and updating a parameter of the data transformer so that the class classification loss is reduced and the lower bound is increased.

13. A non-transitory computer readable medium storing a data transformation program for causing a computer to execute:
data transformation processing for performing data transformation using a data transformer on each of a plurality of data sets belonging to domains different from each other so that data distributions of the plurality of data sets are brought close to each other;
first calculation processing for calculating a class classification loss from a result of class classification performed by a class classifier on at least some of a plurality of first transformed data sets obtained after the data transformation;
second calculation processing for calculating an upper bound and a lower bound of a domain classification loss from a result of domain classification performed by a domain classifier on each of the plurality of first transformed data sets; and
learning processing for performing learning by updating a parameter of the domain classifier so that the upper bound is reduced and updating a parameter of the data transformer so that the class classification loss is reduced and the lower bound is increased.
